(19) United States
(12) Patent Application Publication
(10) Pub. No.: US 2017/0164405 A1
(43) Pub. Date: Jun. 8, 2017

(54) ENABLING OVERLAPPING TRANSMISSIONS IN WIRELESS NETWORK

(71) Applicant: Nokia Technologies Oy, Espoo (FI)

(72) Inventors: Jarkko KNECKT, Espoo (FI); Olli ALANEN, Vantaa (FI)

(21) Appl. No.: 15/325,851

(22) PCT Filed: Jun. 16, 2015
(86) PCT No.: PCT/FI2015/050436

§ 371 Date: Jan. 12, 2017

(30) Foreign Application Priority Data
Jul. 25, 2014 (GB) 1413188.2

(51) Int. Cl. H04W 74/08; H04W 36/00; H04W 40/38; H04W 92/18; H04W 40/36; H04W 84/12; H04W 72/04

(52) U.S. Cl. CPC H04W 74/0808; H04W 84/12; H04W 36/0083; H04W 72/04; H04W 92/18; H04W 40/36; H04W 40/38

(57) ABSTRACT

This document discloses a solution where a wireless device may allow another wireless device to transmit an overlapping transmission. According to an embodiment, upon determining that a channel is idle in a clear channel assessment procedure, the wireless device causes transmission of a frame during a transmission interval, wherein the frame comprises an information element indicating that the apparatus allows another apparatus to carry out transmission overlapping with the transmission interval.

### FIELD

The invention relates to the field of wireless networks and, particularly, to managing overlapping transmissions in a wireless network.

### BACKGROUND

In some wireless networks, a plurality of wireless devices may attempt to access a transmission medium at the same time. The channel access may comprise sensing the channel for pending transmissions. If the transmission medium is sensed to be busy, a wireless device may back off and attempt the channel access after the channel is sensed to be available. Allowing overlapping transmissions may improve spectrum efficiency but induce interference unless managed properly.

### BRIEF DESCRIPTION

The invention is defined by the independent claims.

Embodiments of the invention are defined in the dependent claims.

### LIST OF DRAWINGS

Embodiments of the present invention are described below, by way of example only, with reference to the accompanying drawings, in which

FIG. 1 illustrates a wireless communication scenario to which embodiments of the invention may be applied;

FIG. 2 illustrates a signalling diagram of a procedure for allowing overlapping transmissions in a wireless network according to an embodiment of the invention;

FIG. 3 illustrates a signalling diagram of a process for determining a reception sensitivity threshold according to an embodiment of the invention;

FIGS. 4 and 5 illustrate processes for determining whether or not to allow overlapping transmissions according to an embodiment of the invention;

FIG. 6 illustrates a process for determining a maximum transmission interval for a transmission opportunity in a wireless device according to an embodiment of the invention;

FIG. 7 illustrates a signalling diagram of a procedure for allowing further allowance of overlapping transmissions according to an embodiment of the invention;

FIGS. 8 and 9 illustrate timing of different reception sensitivity thresholds according to some embodiments of the invention;

FIG. 10 illustrates a block diagram of a structure of an apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A general wireless communication scenario to which embodiments of the invention may be applied is illustrated in FIG. 1. FIG. 1 illustrates wireless communication devices comprising an access point (AP) 100 and a plurality of terminal devices (STA) 112, 114. The AP 100 may be a stationary access point or a mobile access point. A general term used in this specification and encompassing both the APs and STAs is a wireless device. The access point may refer to an access point specified in IEEE 802.11 specifications or to a base station of another wireless access network. The mobile access point may have a functionality of a STA as well. A common term encompassing both the stationary APs and mobile APs is an access node. An access node may provide or be comprised in a basic service set (BSS) which is a basic building block of an IEEE 802.11 wireless local area network (WLAN). Each access node may represent a different BSS. A single access node may, however, establish a plurality of BSSs. The most common BSS type is an infrastructure BSS that includes a single access node together with all STAs associated with the access node. The access node may provide access to other networks, e.g. the Internet. In another embodiment, the BSSs may be connected with each other by a distribution system (DS) to form an extended service set (ESS). An independent BSS (IBSS) is formed by an ad hoc network of terminal devices without a stationary controlling AP. In a context where two BSSs have overlapping coverage areas, one BSS may be considered as an overlapping BSS (OBSS) from the viewpoint of the other BSS. While embodiments of the invention are described in the context of the above-described topologies of IEEE 802.11, it should be appreciated that these or other embodiments of the invention may be applicable to wireless networks based on other specifications, e.g. WiMAX (Worldwide Interoperability for Microwave Access), UMTS LTE (Long-term Evolution for Universal Mobile Telecommunication System), mobile ad hoc networks (MANET), mesh networks, and other networks having cognitive radio features, e.g. transmission medium sensing features and adaptive capability to coexist with radio access networks based on different specifications and/or standards. Some embodiments may be applicable to networks having features under development by other IEEE task groups. Therefore, the following description may be generalized to other systems as well.

The different access nodes may operate at least partly on different channels, e.g. on different frequency channels. IEEE 802.11n specification specifies a data transmission mode that includes 20 megahertz (MHz) wide primary and secondary channels. The primary channel is used in all data transmissions with clients supporting only the 20 MHz mode and with clients supporting higher bandwidths. A further definition in 802.11n is that the primary and secondary channels are adjacent. The 802.11n specification also defines a mode in which a STA may, in addition to the primary channel, occupy one secondary channel which results in a maximum bandwidth of 40 MHz. IEEE 802.11ac task group extends such an operation model to provide for wider bandwidths by increasing the number of secondary channels from 1 up to 7, thus resulting in bandwidths of 20 MHz, 40 MHz, 80 MHz, and 160 MHz. A 40 MHz transmission band may be formed by two contiguous 20 MHz bands, and an 80 MHz transmission band may be formed by two contiguous 40 MHz bands. However, a 160 MHz band may be formed by two contiguous or non-contiguous 80 MHz bands. Different BSSs may employ different primary channels.

As mentioned above, the transmission band of a BSS contains the primary channel and zero or more secondary channels. The secondary channels may be used to increase data transfer capacity of a transmission opportunity (TXOP). The secondary channels may be called a secondary channel, a tertiary channel, a quaternary channel, etc. However, let us for the sake of simplicity use the secondary channel as the common term to refer also to the tertiary or quaternary channel, etc. The primary channel may be used for channel contention, and a TXOP may be gained after successful channel contention on the primary channel. Some IEEE 802.11 networks are based on carrier sense multiple access with collision avoidance (CSMA/CA) for channel access. Some networks may employ enhanced distributed channel access (EDCA) which provides quality-of-service (QoS) enhancements to medium access control (MAC) layer. The QoS enhancements may be realized by providing a plurality of access categories (AC) for prioritizing frame transmissions. The access categories may comprise the following priority levels in the order of increasing priority: background (AC_BK), best effort (AC_BE), video streaming (AC_VI), and voice (AC_VO). A higher priority frame transmission may use a shorter contention window and a shorter arbitration inter-frame spacing (AIFS) that result in higher probability of gaining the TXOP. Furthermore, some networks may employ restricted access windows (RAW) where a reduced set of wireless devices of the wireless network may carry out channel contention. The access node may define the RAW and a group of wireless devices that are allowed to attempt the channel access within the RAW. Grouping allows partitioning of the wireless devices into groups and restricting channel access only to wireless devices belonging to a specified group at any given time period. The time period may be enabled by allocating slot duration and a number of slots in RAW access. The grouping may help to reduce contention by restricting access to the medium only to a subset of the wireless devices. The grouping may also reduce the signalling overhead.

As described above, the BSS may be represented by the access node and one or more terminal devices connected to the access node. In the example of FIG. 1, the access node 100 and the terminal devices 112, 114 may be comprised in the first BSS and, thus, in the same wireless network while other terminal devices and access nodes (not shown) may be comprised in a second BSS which may be a neighbour to the first BSS and an OBSS with respect to the first BSS. This is a common situation in dense deployment scenarios where multiple overlapping wireless networks have been installed. The first BSS and the second BSS may be overlapping BSSs in the sense that at least some of the devices first BSS are capable of receiving frames from the second BSS and vice versa.

With respect to the definition of the wireless network in the context of the present description, the wireless network may comprise a single BSS or a plurality of BSSs. According to a viewpoint, the wireless network may comprise a plurality of BSSs that have the same service set identifier (SSID) the same roaming identifier, and/or the same roaming partnership.

A terminal device may establish a connection with any one of the access nodes it has detected to provide a wireless connection within the neighbourhood of the terminal device. In the example of FIG. 1, let us assume a situation where the terminal devices 112, 114 located within a coverage area 104 of the access node 100 establish a connection to that access node 100. The connection establishment may include authentication in which an identity of the terminal device is established in the access node. The authentication may comprise exchanging an encryption key used in the BSS. After the authentication, the access node and the terminal device may carry out association in which the terminal device is fully registered in the BSS, e.g. by providing the terminal device with an association identifier (AID). It should be noted that in other systems terms authentication and association are not necessarily used and, therefore, the association of the terminal device to an access node should be understood broadly as establishing a connection between the terminal device and the access node such that the terminal device is in a connected state with respect to the access node and scanning for downlink frame transmissions from the access node and its own buffers for uplink frame transmissions.

In a conventional 802.11 network, a wireless device initiating a TXOP may transmit a frame that triggers a network allocation vector (NAV). The frame may be a control frame such as a request-to-send (RTS) frame or a data frame. The frame may comprise a Duration field defining the duration of the NAV. Any other wireless device detecting the frame and extracting the Duration field suspends access to the same channel for the duration of the NAV. This mechanism may reduce simultaneous transmissions in the proximity that may be renamed as collisions. In some collisions the receiver cannot receive transmissions resulting to wasted transmission resources. The 802.11 networks may employ another collision avoidance mechanism called clear-channel assessment (CCA). A wireless device trying to access the channel scans for the channel before the access. If the channel is sensed to contain radio energy that exceeds a CCA threshold, the wireless device refrains from accessing the channel. If the channel is sensed to be free and no NAV is currently valid, the wireless device may access the channel. A conventional value for the CCA threshold may be −82 decibel-milliwatts (dBm) or −62 dBm depending on a channel access scheme, for example.

The wireless devices 110, 112, 114 may employ a randomized back-off time defining a minimum time interval they refrain from frame transmissions after detecting that the channel is busy. During the channel sensing, the back-off time may be decremented while the channel is sensed to be idle or available for the channel access. When the back-off time reduces to zero and the channel is still sensed to be idle, the wireless device may carry out the frame transmission. The back-off time value may be maintained for the duration the channel is sensed to be busy and, in some systems, for a determined guard time interval (e.g. the AIFS) after the detection that the channel has become idle.

In dense deployment scenarios with multiple overlapping wireless networks operating at least partially on the same channel(s), constant backing off may be a reality and it may cause inefficiency in the spectrum utilization. On the other hand, uncontrolled overlapping transmissions potentially increase interference and cause degradation of the performance of the wireless networks. As a consequence, a scheme for enabling overlapping transmissions in a controlled manner may be advantageous.

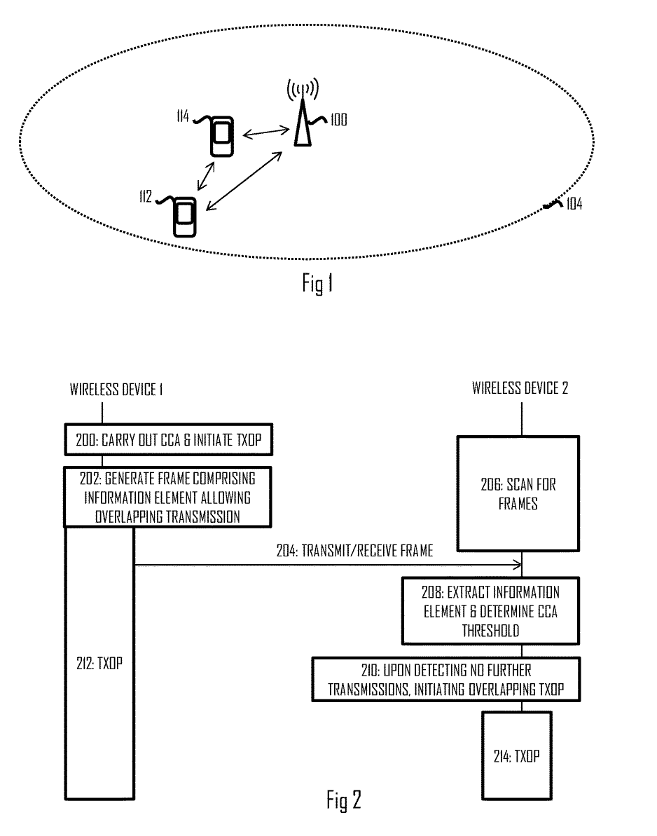

FIG. 2 illustrates a signaling diagram of an embodiment for enabling overlapping transmissions. The procedure of FIG. 2 comprises operations performed in a first wireless device, e.g. the access node 100, and operations performed in a second wireless device, e.g. the terminal device 114. Referring to FIG. 2, the first wireless device performs a clear-channel assessment procedure in which a channel is determined to be idle if no signal having a signal strength exceeding a threshold is detected (block 200). According to another viewpoint, the first wireless device performs a clear-channel assessment procedure in which a channel is determined to be idle if radio energy detected in a channel does not exceed the threshold. In response to determining that the channel is idle, the first wireless device initiates a transmission interval 212. The transmission interval may be a transmission opportunity (TXOP) of the Wi-Fi/IEEE 802.11 networks. In block 202, the wireless device generates a frame during the transmission interval. The frame comprises an information element indicating that another apparatus of the same or different wireless network is allowed to carry out transmission overlapping with the transmission interval. The first wireless device transmits the frame in step 204. Meanwhile, the second wireless device has been scanning the channel(s) of the wireless network for frame transmissions (block 206). As a consequence, the second wireless device detects the frame in step 204 and extracts at least a header of the frame, the header comprising the information element. Upon extracting the information element and detecting that the overlapping transmission is allowed during the transmission interval 212. In response to the information element, the second wireless device employs (block 208) a first threshold mapped to the information element in a clear-channel assessment procedure in which a channel is determined to be idle if no signal having a signal strength exceeding the first threshold is detected. In response to determining that the channel is idle in block 210, the second wireless apparatus initiates a transmission interval 214 overlapping with the transmission interval 212 of the first wireless device.

In an embodiment, the information element allows another apparatus of the same wireless network to carry out the overlapping transmission. In another embodiment, the information element allows another apparatus of another wireless network to carry out the overlapping transmission. In another embodiment, the information element allows another apparatus of the same and different wireless network to carry out the overlapping transmission. In an embodiment, the other apparatus receiving the frame indicating the allowance of the overlapping transmissions may carry out the overlapping transmission if the overlapping transmission is carried out in the same wireless network as where the received frame was transmitted (see the definition of the wireless network above). In another embodiment, the other apparatus receiving the frame indicating the allowance of the overlapping transmissions may carry out the overlapping transmission if the overlapping transmission is carried out in a wireless network that belongs to the same set of wireless networks as the wireless network where the received frame was transmitted. The set of wireless networks may be created according to a determined criterion, e.g. it may consist of wireless networks to which the other apparatus may associate.

In an embodiment, the information element indicating that another apparatus is allowed to carry out transmission overlapping with the transmission interval is comprised in a physical layer convergence protocol (PLOP) header of the frame. In another embodiment, the information element indicating that another apparatus is allowed to carry out transmission overlapping with the transmission interval is comprised in a medium access control (MAC) header of the frame.

In an embodiment, the frame is a PLOP protocol data unit (PPDU). In an embodiment, the frame is the PPDU of a 802.11 network.

In an embodiment, the first wireless device transmits the frame in step 204 as omnidirectional transmission, e.g. transmitting the frame as a radio wave having power distributed substantially uniformly in all directions in a plane around the first wireless device.

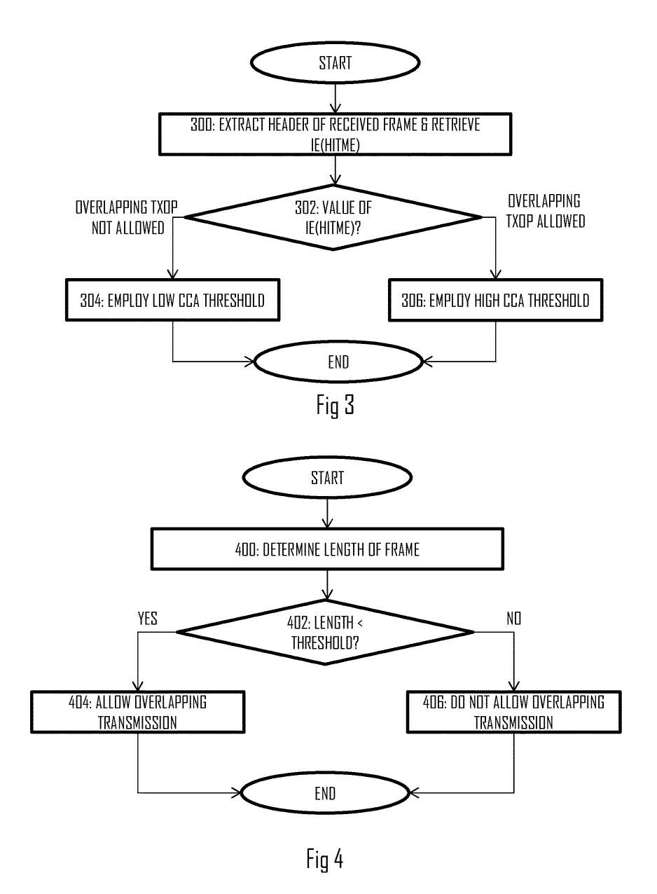

In an embodiment, the second wireless device employs a second, different threshold in the CCA procedure upon detecting no information element allowing the overlapping transmission. The first threshold may be higher than the second threshold, thus increasing the probability of the second wireless device to determine that the channel is idle and the probability of gaining channel access. FIG. 3 illustrates such an embodiment. Referring to FIG. 3, the second wireless device extracts the header of the frame received in step 204 and retrieves the information element indicating whether or not the overlapping transmission is allowed (block 300). In block 302, the second wireless device determines the value of the information element. If the value indicates that the overlapping transmissions are allowed, the process may proceed to block 306 in which the second wireless device employs the higher CCA threshold in the CCA procedure. If the value indicates that the overlapping transmissions are not allowed, the process may proceed to block 304 in which the second wireless device employs the lower CCA threshold in the CCA procedure. In an embodiment, the higher CCA threshold may be any value e.g. between −45 dBm and −55 dBm, e.g. −45 dBm, −50 dBm, or −55 dBm. The lower CCA threshold may be the above-described −62 dBm or −82 dBm or any value e.g. between −60 dBm and −85 dBm or between −60 dBm and −75 dBm. It should be appreciated that the second wireless device may be configured to employ more than two CCA thresholds, e.g. different access classes may have different associated CCA thresholds. In an embodiment, each access class may be associated with at least two thresholds: one used when the overlapping transmissions are allowed in the above-described manner and another used when the overlapping transmissions are not allowed.

In an embodiment of FIG. 3, the second wireless device may determine whether or not the wireless device that transmitted the frame belongs to the same wireless network as the second wireless device If the wireless device that transmitted the frame is determined to belong to the same network, the second wireless device may employ the higher threshold mapped to the information element.

The above-described time interval during which the overlapping transmissions are allowed may comprise the duration the frame indicating the allowance of the overlapping transmissions. In an embodiment, the time interval consists of the duration of the frame. In another embodiment, the time interval comprises a transmission opportunity of the first wireless device transmitting the frame, wherein the transmission opportunity may be longer than the duration of the frame. In yet another embodiment, the time interval may comprise the duration of the frame and a determined time interval after the frame.

When the transmitting device (the first wireless device) controls the overlapping transmissions with the information element called “HitMe” in the following and in the Figures, the transmitting device may have the control when to allow the overlapping transmissions in such manner that interference levels stay in sustainable levels. In an embodiment, the overlapping transmissions are allowed when the transmitting device transmits a short frame. FIG. 4 illustrates such an embodiment of a process for determining whether or not to allow overlapping transmissions for a frame being transmitted from the first wireless device during the transmission interval initiated in block 200. Referring to FIG. 4, the first wireless device determines the length of the frame in block 400. The length of the frame may be determined from a type of the frame and/or from an expected duration of the frame transmission. The type of the frame may comprise a management message, a data message, an acknowledgment message, etc. The duration may be a value inserted to a duration field in a header of the transmitted frame, the duration field indicating the length of the frame to a receiver of the header. In block 402, the length of the frame is compared with a threshold. If the length is shorter than the threshold (“YES” in FIG. 4), the process proceeds to block 404 in which the first wireless device selects a value of the information element “HitMe” to indicate that the overlapping transmissions are allowed. If the length is longer than the threshold (“NO” in FIG. 4), the process proceeds to block 406 in which the first wireless device selects a value of the information element “HitMe” to indicate that the overlapping transmissions are not allowed. The threshold may be, for example 200 microseconds or 300 octets. In other embodiments, the threshold may be any value between 150 and 250 microseconds or between 200 and 400 octets.

In another embodiment, the overlapping transmissions are allowed when the transmitting device transmits a frame with a low-order modulation and coding scheme. The low-order modulation and coding scheme (MCS) may be considered as a MCS that sustains interference better than a high-order MCS. The low-order MCS may employ stronger modulation and stronger channel coding than the high-order MCS. FIG. 5 illustrates such an embodiment of a process for determining whether or not to allow overlapping transmissions for a frame being transmitted from the first wireless device during the transmission interval initiated in block 200. Referring to FIG. 5, the first wireless device determines the modulation and coding scheme (MCS) for the frame in block 500. The MCS may be determined at least partially on the basis of a channel quality between the first wireless device and another wireless device to which the frame is addressed. In an embodiment, the MCS selected in block 500 has a lower order than a minimum requirement set for the MCS by the channel quality. Conventionally, the channel quality sets a requirement for the order of the MCS, wherein a poorer channel quality requires a lower order MCS while a better channel quality allows a higher order MCS. In block 502, the selected order of the MCS is compared with the minimum requirement set for the channel quality. If the selected order is lower than the minimum requirement (“YES” in FIG. 5), it is assumed that the selected MCS is more robust against interference than what is set by the minimum requirement and, as a consequence, is considered to sustain further interference potentially caused by the overlapping transmission(s). The process may then proceed to block 404 in which the first wireless device selects a value of the information element “HitMe” to indicate that the overlapping transmissions are allowed. If the selected order is the minimum requirement or even higher than the minimum requirement (“NO” in FIG. 5), it is assumed that the selected MCS cannot sustain further interference potentially caused by the overlapping transmission(s). The process may then proceed to block 406 in which the first wireless device selects a value of the information element “HitMe” to indicate that the overlapping transmissions are not allowed.

In an embodiment, block 500 comprises intentionally selecting a lower-order MCS than that necessitated by the estimated channel quality. Then, block 500 may comprise determining the MCS necessitated by the channel quality and decreasing the order of the MCS by a determined degree. In another embodiment where certain frames are transmitted with a certain MCS, block 500 comprises selecting a MCS mapped to the frame and, in block 502, it is determined whether or not the MCS is the minimum requirement for the current channel quality.

In another embodiment, the overlapping transmissions are allowed when the transmitting device transmits a short frame with the low-order modulation and coding scheme. This embodiment is basically a combination of the embodiments of FIGS. 4 and 5 such that the block 404 is executed only if the result is “YES” in both blocks 402, 502. Otherwise, block 406 is executed.

In yet another embodiment, the overlapping transmissions are allowed when the transmitting device transmits a determined type of frame. In this embodiment, upon determining to transmit a frame, the transmitting device may determine a type of the frame. If the type of the frame is mapped to a set of frame types for which the overlapping transmissions are allowed, the transmitting device may set the value of the “HitMe” information element to indicate that the overlapping transmissions are allowed. On the other hand, if the type of the frame is mapped to a set of frame types for which the overlapping transmissions are not allowed, the transmitting device may set the value of the “HitMe” information element to indicate that the overlapping transmissions are not allowed. The set of frame types of the frame for which the overlapping transmissions are allowed may comprise at least one of a management frame, a short data frame, an acknowledgment frame, and a block acknowledgment frame. The definition of the short may be considered as a frame having the length smaller than the above-described threshold for the length of the frame in block 402.

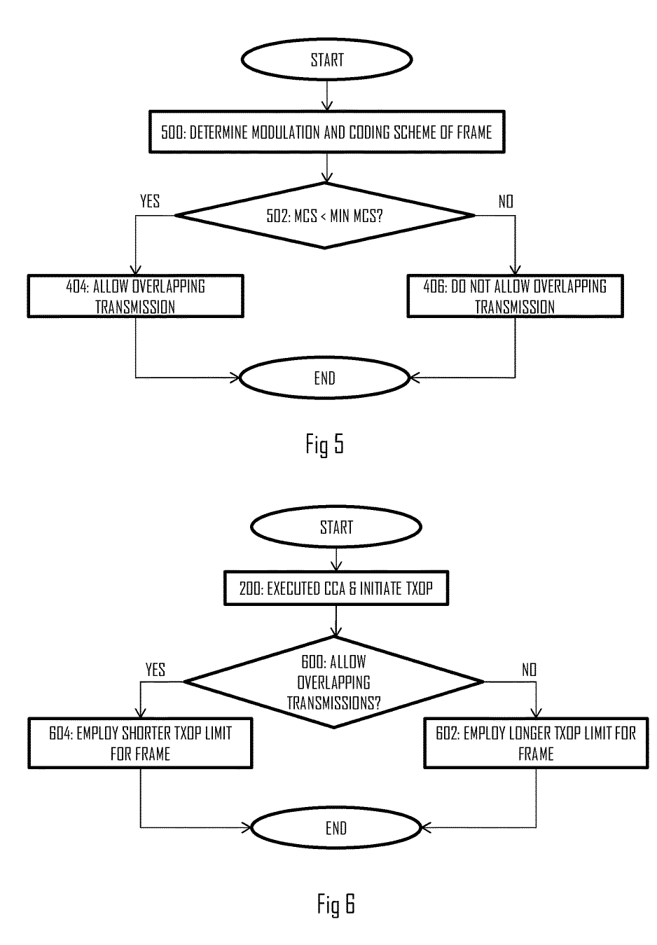

In an embodiment, the transmission interval of the first wireless device is defined by a maximum duration of a transmission opportunity of the first wireless device. The maximum duration may be shorter for the frame comprising the information element indicating that the overlapping transmission is allowed than for another frame indicating that the overlapping transmission is not allowed. As a consequence, the first wireless device may allow the overlapping transmissions only when transmitting short frames that are, in some embodiments, transmitted with a robust low-order MCS. Such short frames may include acknowledgment frames, block acknowledgment frames, and short data frames, for example. The duration may be defined by a dot11HitMeTXOPLimit parameter specified in IEEE 802.11 networks separately for the short frames that allow overlapping transmissions. For a conventional frame having a long duration and/or a MCS matched to the minimum requirement set by the channel quality another, longer duration specified by parameter dot11TXOPLimit may be employed. FIG. 6 illustrates an embodiment for determining the length of the transmission interval for the frame. When initiating the TXOP, the first wireless device may determine the frame being transmitted and whether or not to allow overlapping transmissions for the frame (block 600). If the overlapping transmissions are allowed and a corresponding “HitMe” information element inserted into the header of the frame, the process may proceed to block 604 in which the shorter TXOP limit is employed for the frame. On the other hand, if the overlapping transmissions are not allowed for the frame because of the order of the MCS and/or the great length of the frame, for example, the process may proceed to block 602 in which the longer TXOP limit is employed for the frame.

The frame transmitted by the first wireless device may further comprise an information element indicating whether or not the wireless device carrying out the overlapping transmission may allow further overlapping transmissions. This information element may be the same information element described above that indicates whether or not the overlapping transmissions are allowed, or the information element may be a logically different information element. In one embodiment, the “HitMe” information element may have four logical values defined in Table 1 below. Table 1 illustrates four two-bit values for the “HitMe” information element that are merely exemplary.

TABLE 1

| | Overlapping | Overlapping |
|---|---|---|
| | TXOP | TXOP not |
| | Allowed | Allowed |
| Further Allowance of | 10 | 01 |
| overlapping TXOPs | | |
| allowed | | |
| Further Allowance of | 00 | 11 |
| overlapping TXOPs | | |
| not allowed | | |

In another embodiment, another information element is used to indicate whether or not the wireless device initiating the overlapping TXOP is allowed to “spread” the information on the possibility for the overlapping TXOPs. Let us call that other information element a “Continuation” element that may be provided in the header in a separate field with respect to the “HitMe” information element. The Continuation element may indicate to a receiver of the frame whether or not it may set the value of the HitMe element of a frame it transmits as the overlapping transmission to indicate that further transmissions are allowed.

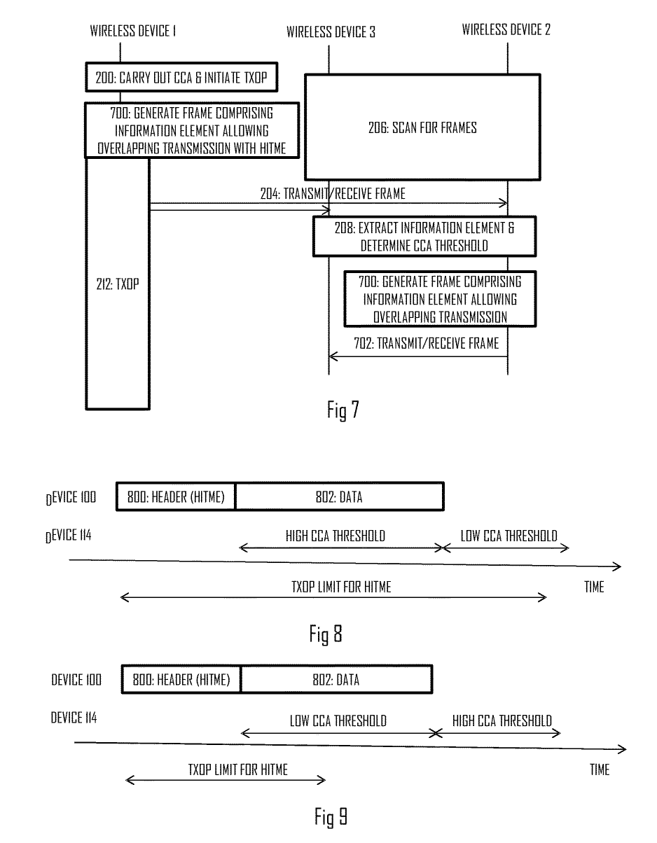

FIG. 7 illustrates an embodiment for determining, in the second wireless device on the basis of the frame received from the first wireless device, whether or not to allow the further overlapping transmissions. Blocks with the same reference numbers as in FIG. 2 represent substantially similar operations. FIG. 7 illustrates a third wireless device which may be the terminal device 112 of FIG. 1. Referring to FIG. 7, the first wireless device generates the frame that indicates that overlapping transmissions are allowed. Block 700 may comprise determining whether or not to allow the other wireless devices to allow further overlapping transmissions if they determine to initiate the overlapping transmission. The determination may be based on the type of the frame. The further allowance of the overlapping transmissions may be prevented when the frame being generated in block 700 is considered important, e.g. an acknowledgment frame, a block acknowledgment frame, a broadcast frame, or a multicast frame. The further allowance of the overlapping transmissions may be prevented when the frame being generated in block 700 is a unicast data frame, for example. A prerequisite for the determining whether or not to allow the other wireless devices further allow overlapping transmissions may be that the first wireless device itself has decided to allow the overlapping transmissions during the time interval of the frame. Let us now assume that the first wireless device allows the further allowance of the overlapping transmissions. As a consequence, the first wireless device may set the value of the at least one information element to indicate that the other wireless devices are allowed to allow further overlapping transmissions. Then, the frame is transmitted by the first wireless device and received by the second and third wireless devices in step 204. The second and third wireless devices extract the information element(s) from the received frame in block 208 and determine the CCA threshold to be used in the CCA procedure. Let us assume that the second wireless device has a frame to transmit to the third wireless device during the TXOP 212 of the first wireless device. Upon using the high CCA threshold as a result of the HitMe information element set to allow overlapping transmissions, let us further assume that the second wireless device determines the channel to be idle. As a result, the second wireless device executes functions of block 700 and chooses to set the information element HitMe to allow further overlapping transmissions, as allowed by the frame received in step 204. The second wireless device may carry out the same functions as the first wireless device in block 700 with respect to determining whether or not to allow the other wireless devices to allow further overlapping transmissions. The frame is then transmitted to the third wireless device in step 702 during the TXOP 212 of the first wireless device.

In an embodiment, the second wireless device may determine, before initiating the overlapping TXOP, whether or not the second wireless device itself or the third wireless device addressed with the potential overlapping transmission is an intended recipient of the frame received in step 204. This may be determined from a receiver address comprised in the received frame. If the receiver address is an address associated with the second wireless device or an address associated with the third wireless device, the second wireless device may choose not to carry out the overlapping transmission. Otherwise, it may choose to carry out the overlapping transmission. In this manner, the wireless device may check whether or not the wireless device itself or its intended recipient is busy and, if at least one of them considered busy, prevent the overlapping transmission. For example, if an access node is receiving a frame from the a terminal device allowing the overlapping transmissions during the transmission of the frame, another terminal device having a frame to be transmitted to the access node may prevent the overlapping transmission when considering the access node to be busy.

Let us now consider some embodiments with respect to the timing of the different CCA thresholds employed in the CCA procedure. As described above, the reception of a frame comprising the “HitMe” information element allowing overlapping transmissions may allow the use of a higher CCA threshold during the TXOP of the wireless device transmitting the “HitMe” information element. The timing for using the higher CCA threshold may be determined on the basis of one or more information elements comprised in the received frame. In an embodiment, the one or more information elements of the received frame may allow the use of the higher CCA threshold only for the duration of the frame. This embodiment is illustrated in FIG. 8. Referring to FIG. 8, a wireless device 100 may transmit a frame comprising a header 800 and a data field 802. The header may comprise the information element allowing the overlapping transmissions (HitMe) and the use of the higher CCA threshold and the one or more information elements allowing the use of the higher CCA threshold only for the duration of the frame. The duration of the TXOP of the wireless device 100 may be longer than the duration of the frame, as illustrated in FIG. 8. Upon determining from the header 800 that the higher CCA threshold is allowed to use only during the frame and upon determining to carry out the CCA procedure during the frame, a wireless device 114 may employ the higher CCA threshold in the CCA procedure during a time interval between a time instant when the header ends and a time instant when the frame ends, as illustrated in FIG. 8. After the frame has ended, the wireless device is configured to employ the lower CCA threshold.

In an embodiment, the one or more information elements allowing the use of the higher CCA threshold only for the duration of the frame may be the Continuation element and, particularly, a specific value of the Continuation element.

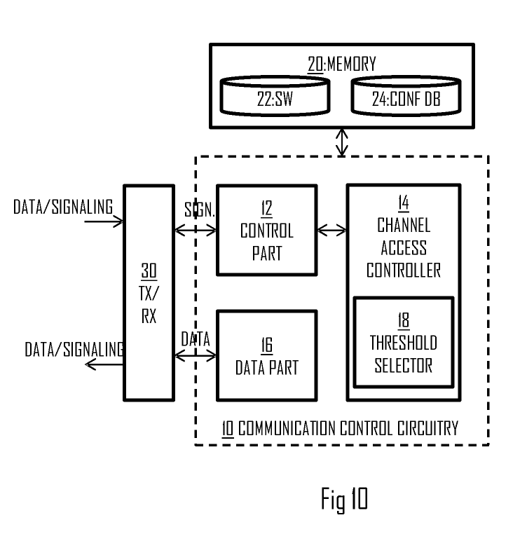

In another embodiment, the one or more information elements allowing the use of the higher CCA threshold only for the duration of the frame may be a combination of the HitMe element allowing the overlapping transmissions and a specific value or range of values of a Duration element comprised in the header 800. The Duration element indicates the length of the frame. FIGS. 8 and 9 illustrate the use of the CCA thresholds as a function of said combination. Referring to FIG. 8, the wireless device 114 receiving the frame and extracting the header 800 determines, on the basis of the value of the “HitMe” element that the overlapping transmission and the use of the higher CCA threshold are allowed. The wireless device 114 may further extract the value of the Duration field in the header and compare the value of the Duration field with a reference duration value. The reference duration value may be the maximum duration of the TXOP allowed for the TXOPs containing a frame allowing the overlapping transmissions (TXOP Limit for “HitMe” in FIGS. 8 and 9). If the value of the Duration field is lower than the maximum duration of the TXOP applicable to the received frame, the wireless device 114 may determine that the higher CCA threshold is applicable only for the duration of the frame (FIG. 8). After the frame ends, the wireless device may be configured to employ the lower CCA threshold. In another embodiment used when the value of the Duration field is lower than the maximum duration of the TXOP applicable to the received frame, the wireless device 114 may determine that the higher CCA threshold is applicable for a determined time interval counted from the end of the header 800. The determined time interval may be specified in a configuration data of the wireless network, e.g. provided in a management message transmitted by the access node 100, or the length of the determined time interval may be indicated in the header 800. Let us call such an information element defining the length of the determined time interval when the higher CCA threshold is applicable as dot11HitMeInitiationLimit.

On the other hand, if the value of the Duration field is higher than the maximum duration of the TXOP applicable to the received frame, the wireless device 114 may determine that the higher CCA threshold is applicable only after the frame has ended. The wireless device 114 may then assume that the frame has been transmitted with the MCS matched to the channel quality and without a safety margin in the order of the MCS. Accordingly, the wireless device 114 may be configured to use the lower CCA threshold during the frame. After the frame ends, the wireless device 114 may be configured to employ the higher CCA threshold for the above-described determined time interval, e.g. the dot11HitMeInitiationLimit. In this embodiment, the wireless device 114 may start counting the time interval from the end of the header 800 or from the end of the frame. Even in the case the time interval is counted from the end of the header 800, the higher CCA threshold may be applicable only after the frame has ended. Accordingly, the time interval may be shorter with respect to the embodiment where the same time interval is counted from the end of the frame.

In an embodiment, the above-described time interval dot11HitMeInitiationLimit may be used as a time interval for transmitting the overlapping transmission allowing further overlapping transmissions. For example, the first wireless device may send the frame allowing overlapping transmissions, as described above in FIGS. 2 and 7. If the duration of the frame is lower than the maximum duration of the TXOP (dot11HitMeTXOPLimit), another wireless device (e.g. the second wireless device) is allowed to transmit, during the time interval of the dot11HitMeInitiationLimit measured from the time when the header is received (e.g. the end of the header), an overlapping frame allowing further overlapping transmissions. On the other hand, if the duration of the frame is higher than the maximum duration of the TXOP (dot11HitMeTXOPLimit), another wireless device (e.g. the second wireless device) is allowed to transmit, during the time interval of the dot11HitMeInitiationLimit measured from the end of the frame, an overlapping frame allowing further overlapping transmissions.

In an embodiment, the ability to allow the overlapping transmissions may be time-limited even for the first wireless device considered above as an originator of the allowance of the overlapping transmissions. The time-limitation may be associated with the above-described RAWs, e.g. the overlapping transmissions may be allowed only during the RAW. In a further embodiment, a special time interval or a sub-period within the RAW may be defined when the wireless devices may be configured to allow overlapping transmissions, if they choose to allow them.

FIG. 10 illustrates an embodiment of an apparatus comprising means for carrying out the above-mentioned functionalities of the wireless device, e.g. a terminal device, user equipment, a client device, or the access node. The wireless device may comply with specifications of an IEEE 802.11 network and/or another wireless network. The wireless device may also be a cognitive radio apparatus capable of adapting its operation to a changing radio environment, e.g. to changes in parameters of another system on the same frequency band. The wireless device may be or may be comprised in a computer (PC), a laptop, a tablet computer, a cellular phone, a palm computer, an access point, a base station, or any other apparatus provided with radio communication capability. In another embodiment, the apparatus carrying out the above-described functionalities of the wireless device is comprised in such a wireless device, e.g. the apparatus may comprise a circuitry, e.g. a chip, a chipset, a processor, a micro controller, or a combination of such circuitries in the wireless device.

Referring to FIG. 10, the apparatus may comprise a communication controller circuitry 10 configured to control wireless communications in the wireless device. The communication controller circuitry 10 may configure the establishment, operation, and termination of connections or associations in the apparatus, as described above. The communication controller circuitry 10 may comprise a control part 12 handling control signalling communication with respect to transmission, reception, and extraction of control or management frames including beacon messages, request messages, response messages, scanning or probing messages, RTS messages, and clear-to-send (CTS) messages. The control part 12 may also carry out processing of headers of data frames. The communication controller circuitry 10 may further comprise a data part 16 that handles transmission and reception of payload data when the apparatus is associated to one or more other wireless devices.

The communication control circuitry 10 may further comprise a channel access controller 14 configured to determine transmission opportunities of the wireless device. The channel access controller 14 may employ the above-described channel sensing procedure (CCA procedure) in which the channel is sensed for conflicting frame transmissions that prevent the channel access of the wireless device. The channel access controller 14 may comprise a threshold selector circuitry 18 for selecting the reception sensitivity threshold (e.g. the CCA threshold) in the above-described manner. The control part 12 may be configured to monitor for frames transmitted by other wireless devices and extract one or more information elements indicating the allowance of the overlapping transmissions. The control part 12 may output such information elements or information contained in such information elements to the channel access controller 14. The selector circuitry of the channel access controller 14 may then select which one of a plurality of reception sensitivity thresholds to employ at a time. Upon determining to attempt channel access, the channel access controller 14 may control the control part 12 to carry out the channel sensing and determine whether or not a signal stronger than the reception sensitivity threshold currently selected by the selector circuitry is detected. As described above, the higher threshold may be employed if the overlapping transmissions are currently allowed. Upon determining that the channel is idle, the channel access controller 14 may initiate frame transmission.

The circuitries 12 to 18 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 18 or all of them.

The apparatus may further comprise a memory 20 that stores computer programs (software) 22 configuring the apparatus to perform the above-described functionalities of the wireless device. The memory 20 may also store communication parameters and other information needed for the wireless communications. The memory 20 may store a configuration database 24 storing configuration parameters of a wireless network of the wireless device. The configuration database may store, for example, a plurality of reception sensitivity threshold values and rules when to apply each threshold value. The rules may comply with the above-described embodiments for using the plurality of thresholds (e.g. CCA thresholds). The configuration database 24 may further store rules for carrying out the overlapping transmissions upon detecting that another wireless device has allowed the overlapping transmissions. The configuration database 24 may further store rules for allowing other wireless devices to carry out transmissions that overlap with a transmission by the apparatus.

The apparatus may further comprise radio interface components 30 providing the apparatus with radio communication capabilities within one or more wireless networks. The radio interface components 30 may comprise standard well-known components such as an amplifier, filter, frequency-converter, (de)modulator, and encoder/decoder circuitries and one or more antennas. The apparatus may in some embodiments further comprise a user interface enabling interaction with the user of the communication device. The user interface may comprise a display, a keypad or a keyboard, a loudspeaker, etc.

In an embodiment, the apparatus carrying out the embodiments of the invention in the wireless device comprises at least one processor 10 and at least one memory 20 including a computer program code 22, wherein the at least one memory and the computer program code are configured, with the at least one processor, to cause the apparatus to carry out the functionalities of the wireless device according to any one of the embodiments of FIGS. 2 to 9. According to an aspect, when the at least one processor 10 executes the computer program code, the computer program code causes the apparatus to carry out the functionalities of the wireless device according to any one of the embodiments of FIGS. 2 to 9. According to another embodiment, the apparatus carrying out the embodiments of the invention in the wireless device comprises the at least one processor 10 and at least one memory 20 including a computer program code 22, wherein the at least one processor 10 and the computer program code 22 perform the at least some of the functionalities of the wireless device according to any one of the embodiments of FIGS. 2 to 9. Accordingly, the at least one processor, the memory, and the computer program code form processing means for carrying out embodiments of the present invention in the wireless device. According to yet another embodiment, the apparatus carrying out the embodiments of the invention in the wireless device comprises a circuitry including at least one processor 10 and at least one memory 20 including computer program code 22. When activated, the circuitry causes the apparatus to perform the at least some of the functionalities of the wireless device according to any one of the embodiments of FIGS. 2 to 9.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 7 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1-34. (canceled)

35. A method comprising:
detecting, by an apparatus of a wireless network, a frame transmitted by another apparatus during a transmission interval of the other apparatus, wherein the frame comprises an information element indicating that the other apparatus allows transmission overlapping with the transmission interval;
in response to the information element, employing in the apparatus a first threshold mapped to the information element in a clear-channel assessment procedure in which a channel is determined to be idle if radio energy detected in the channel does not exceed the first threshold;
in response to determining that the channel is idle, causing transmission overlapping with the transmission interval of the other apparatus.

36. The method of claim 35, further comprising employing, in the apparatus, a second threshold different from the first threshold in the clear-channel assessment procedure, in response to detecting no information element indicating that the transmission overlapping with the transmission interval is allowed.

37. The method of claim 36, wherein the second threshold is lower than the first threshold.

38. The method of claim 35, wherein the frame further comprises a second information element indicating a time interval when the first threshold shall be used.

39. The method of claim 38, wherein the second information element indicates that the first threshold shall be used only for the duration of the frame.

40. The method of claim 35, further comprising:
determining whether or not the other apparatus that transmitted the frame belongs to the wireless network; and
employing in the apparatus the first threshold mapped to the information element and causing the transmission overlapping with the transmission interval of the other apparatus if the other apparatus is determined to belong to the same network.

41. A method comprising:
employing, by an apparatus of a wireless network, a threshold for a clear-channel assessment procedure in which a channel is determined to be idle if radio energy detected in the channel does not exceed the threshold is detected;
in response to determining that the channel is idle, initiating a transmission interval;
causing transmission of a frame during the transmission interval, wherein the frame comprises an information element indicating that the apparatus allows another apparatus to carry out transmission overlapping with the transmission interval.

42. The method of claim 41, further comprising:
determining an order of a modulation and coding scheme selected for the frame with respect to a minimum modulation and coding scheme necessitated by a channel quality;
if the order of a modulation and coding scheme selected for the frame is more interference-tolerant than the minimum modulation and coding scheme, setting a value of the information element to indicate that the overlapping transmission is allowed; and
if the order of a modulation and coding scheme selected for the frame is the minimum modulation and coding scheme, setting a value of the information element to indicate that the overlapping transmission is not allowed.

43. The method of claim 41, wherein at least one of said information element and another information element comprised in the frame indicates whether or not the other apparatus is allowed to include in a frame transmitted during the transmission interval or during a determined time interval following the transmission interval an information element indicating that a further overlapping transmission is allowed.

44. The method of claim 41, wherein the transmission interval defines a maximum duration of a transmission opportunity of the apparatus, and wherein the maximum duration is shorter for the frame comprising the information element indicating that the overlapping transmission is allowed than for another frame indicating that the overlapping transmission is not allowed.

45. The method of claim 41, further comprising causing transmission of the frame during the transmission interval as omnidirectional transmission.

46. An apparatus comprising:
at least one processor; and at least one memory including a computer program code, wherein the at least one memory and the computer program code are configured, with the at least one processor, to cause the apparatus to:
detect a frame transmitted by another apparatus during a transmission interval of the other apparatus, wherein the frame comprises an information element indicating that the other apparatus allows transmission overlapping with the transmission interval;
in response to the information element, employ a first threshold mapped to the information element in a clear-channel assessment procedure in which a channel is determined to be idle if radio energy detected in the channel does not exceed the first threshold;
in response to determining that the channel is idle, cause transmission overlapping with the transmission interval of the other apparatus.

47. The apparatus of claim 46, wherein the at least one memory and the computer program code are configured, with the at least one processor, to cause the apparatus to employ a second threshold different from the first threshold in the clear-channel assessment procedure, in response to detecting no information element indicating that the transmission overlapping with the transmission interval is allowed.

48. The apparatus of claim 47, wherein the second threshold is lower than the first threshold.

49. The apparatus of claim 46, wherein the frame further comprises a second information element indicating a time interval when the first threshold shall be used.

50. The apparatus of claim 49, wherein the second information element indicates that the first threshold shall be used only for the duration of the frame.

51. The apparatus of claim 46, wherein the at least one memory and the computer program code are configured, with the at least one processor, to cause the apparatus to:
determine whether or not the other apparatus that transmitted the frame belongs to the wireless network; and
employ in the apparatus the first threshold mapped to the information element and cause the transmission overlapping with the transmission interval of the other apparatus if the other apparatus is determined to belong to the same network.

52. An apparatus comprising:
at least one processor; and
at least one memory including a computer program code, wherein the at least one memory and the computer program code are configured, with the at least one processor, to cause the apparatus to:
employ a threshold for a clear-channel assessment procedure in which a channel is determined to be idle if no signal having a signal strength exceeding the threshold is detected;
in response to determining that the channel is idle, initiate a transmission interval;
cause transmission of a frame during the transmission interval, wherein the frame comprises an information element indicating that the apparatus allows another apparatus to carry out transmission overlapping with the transmission interval.

53. The apparatus of claim 52, wherein the at least one memory and the computer program code are configured, with the at least one processor, to cause the apparatus to:
determine an order of a modulation and coding scheme selected for the frame with respect to a minimum modulation and coding scheme necessitated by a channel quality;
if the order of a modulation and coding scheme selected for the frame is more interference-tolerant than the minimum modulation and coding scheme, set a value of the information element to indicate that the overlapping transmission is allowed; and
if the order of a modulation and coding scheme selected for the frame is the minimum modulation and coding scheme, set a value of the information element to indicate that the overlapping transmission is not allowed.

54. The apparatus of claim 52, wherein at least one of said information element and another information element comprised in the frame indicates whether or not the other apparatus is allowed to include in a frame transmitted during the transmission interval or during a determined time interval following the transmission interval an information element indicating that a further overlapping transmission is allowed.

55. The apparatus of claim 52, wherein the transmission interval defines a maximum duration of a transmission opportunity of the apparatus, and wherein the maximum duration is shorter for the frame comprising the information element indicating that the overlapping transmission is allowed than for another frame indicating that the overlapping transmission is not allowed.

56. The apparatus of claim 52, wherein the at least one memory and the computer program code are configured, with the at least one processor, to cause the apparatus to cause transmission of the frame during the transmission interval as omnidirectional transmission.
